(19) United States
(12) Patent Application Publication
(10) Pub. No.: US 2014/0098234 A1
(43) Pub. Date: Apr. 10, 2014

(54) IMAGE PROCESSING SYSTEM AND RELATED MONITORING SYSTEM

(71) Applicants: DJB GROUP, Columbus, OH (US); WISTRON NEWEB CORPORATION, Taiwan (CN)

(72) Inventors: Yu-Min Ho, Hsinchu (TW); Walter D. Burnside, Columbus, OH (US)

(21) Appl. No.: 14/118,240

(22) PCT Filed: May 18, 2011
(86) PCT No.: PCT/CN2011/074213

§ 371 Date: Nov. 18, 2013

(51) Int. Cl. G08B 13/196; G08B 13/24; G06T 1/00

(52) U.S. Cl. CPC G08B 13/19656; G06T 1/0021; G08B 13/2462
USPC 348/152; 382/100

(57) ABSTRACT

An image processing system is disclosed. The image processing system comprises a radio frequency identification (RFID) reader unit, a microprocessor module and a memory unit. The RFID reader unit is used for retrieving tag data, wherein the tag data comprises timing stamp information. The microprocessor module is coupled to the RFID reader unit, and used for receiving image data and correlating the tag data with the image data to generate combination data, wherein the combination data comprises information of the tag data and the image data. The memory unit is coupled to the microprocessor module, and used for storing the combination data.

### FIELD OF INVENTION

The present invention relates to an image process system and a related monitoring system, and more particularly, to an image process system and a related monitoring system to correlate captured image data with received tag data.

### BACKGROUND OF THE INVENTION

Radio Frequency Identify (RFID) tags, readers, and antennas are currently being used and being developed as tools to keep track of inventory of goods at specific sites such as retail stores, warehouses, and the like. In some situations, it is desirable to identify and track goods on an item level basis. It is further desirable that the inventory data for all of the goods at a site be stored in a main or host computer at the site or at a remote location.

A difficulty exists where it is desired to have inventory data available on a real time or nearly instantaneous basis. Where the inventory of goods is extensive and the goods are to be tracked on an item level basis, current systems require massive amounts of data to be transmitted from numerous readers to a main computer. A bottleneck can exist at the main computer where the readers attempt to identify all of the tagged items simultaneously or serially to the main computer.

A conventional monitoring system uses cameras to video-film object items. In order to cut down the cost, those cameras used in the conventional monitoring system do not have high quality. Therefore, images captured by those cameras are blurry or low resolution. It's hard to identify a particular item within the images. In addition, those images do not show much information on it. Once expensive goods are stolen or moved, the retail is not able to track the stolen goods by reading those blurry images.

### SUMMARY OF THE INVENTION

It is therefore an objective to provide an image Processing System and a related monitoring system.

The present invention discloses an image processing system. The image processing system comprises a radio frequency identification (RFID) reader unit, a microprocessor module and a memory unit. The RFID reader unit is used for retrieving tag data, wherein the tag data comprises timing stamp information. The microprocessor module is coupled to the RFID reader unit, and used for receiving image data and correlating the tag data with the image data to generate combination data, wherein the combination data comprises information of the tag data and the image data. The memory unit is coupled to the microprocessor module, and used for storing the combination data.

The present invention further discloses a monitoring system. The monitoring system comprises an antenna array, a camera set and an image processing system. The antenna array is used for receiving tag data corresponding to a plurality of objects. The camera set is used for capturing images of the plurality of objects and generating image data according to the images and comprises at least one camera module. The image processing system is coupled to the camera set for processing the image data and the tag data. The image processing system comprises a RFID reader unit, a microprocessor module and a memory unit. The RFID reader unit is used for retrieving tag data, wherein the tag data comprises timing stamp information. The microprocessor module is coupled to the RFID reader unit, and used for receiving image data and correlating the tag data with the image data to generate combination data, wherein the combination data comprises information of the tag data and the image data. The memory unit is coupled to the microprocessor module, and used for storing the combination data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an exemplary monitoring system.

FIG. 2A is a schematic diagram of an exemplary image processing system.

FIG. 2B illustrates an exemplary data structure of combination data.

FIG. 3 is a schematic diagram of an exemplary camera module.

FIG. 4 is a schematic diagram of another exemplary image processing system.

FIG. 5 illustrates connection between a camera module and an image processing system.

FIG. 6 illustrates connection between two camera modules and an image processing system.

FIG. 7 illustrates connection between eight camera modules and an image processing system.

FIG. 8 is a schematic diagram of a camera switch unit.

FIG. 9 illustrates an exemplary camera deployment of a camera set.

FIG. 10 illustrates another exemplary camera deployment of a camera set.

### DETAILED DESCRIPTION

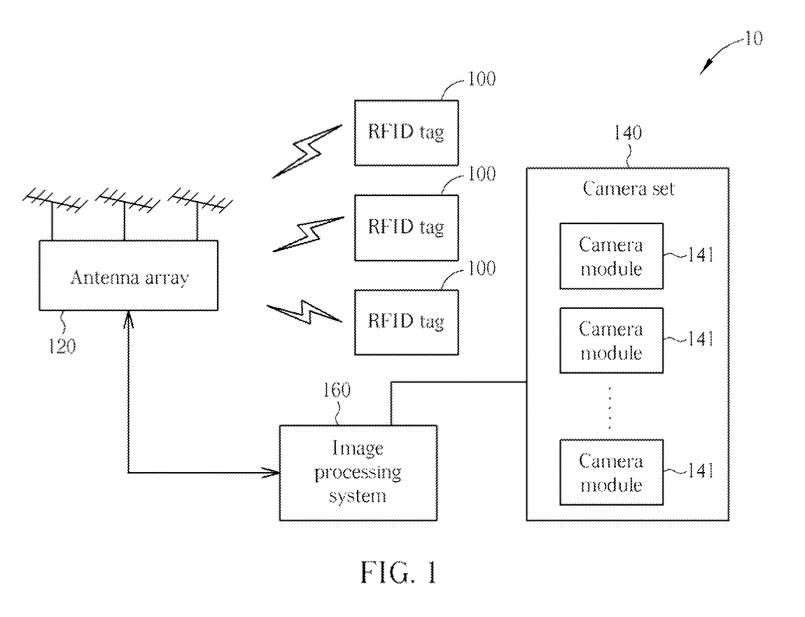

Please refer to FIG. 1, which is a schematic diagram of an exemplary monitoring system 10. The monitoring system 10 comprises multiple radio frequency identification (RFID) tags 100, an antenna array 120, a camera set 140, an image processing system 160. Each of the RFID tags 100 is attached to an object. Each RFID tag 100 is a microchip combined with an antenna in a compact package. With the RFID tags 100, the objects can be tracked and identified. The antenna array 120 includes multiple antennas which may be deployed in appreciate locations to optimally receive tag data from the RFID tags 100. The tag data may include timing stamp information and identities associated with each object. The timing stamp information indicates which image frame a user may be interested in. Each of the identities is unique for each object. The number of the antennas is preferably four or can be extended to sixteen, but not limited herein. The camera set 140 includes one or more camera modules 141 and is used for capturing images of the objects and generating image data according to the images. The camera set 140 can be located at places where field of view of the camera set 140 can cover the overall imaging zone. The image processing system 160 is coupled to the camera set 140 and used for processing the image data and the tag data. Through the image processing system 160, the image data is correlated with the tag data, thereby generating combination data. Since the combination data includes timing stamp information and identities, the user can easily track the objects once the objects have been stolen or moved.

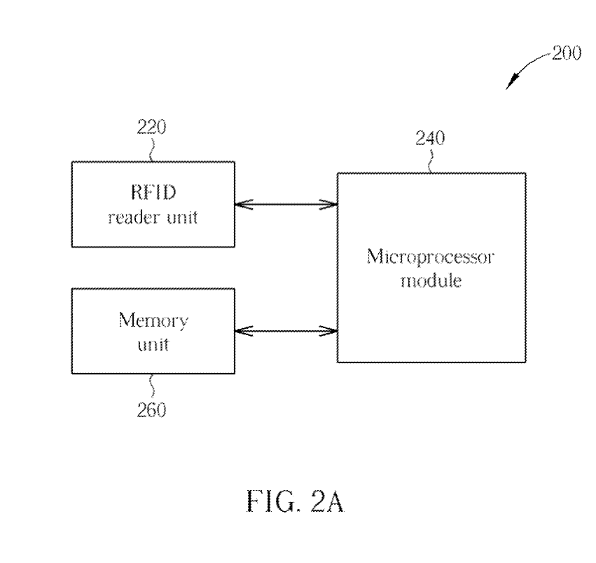

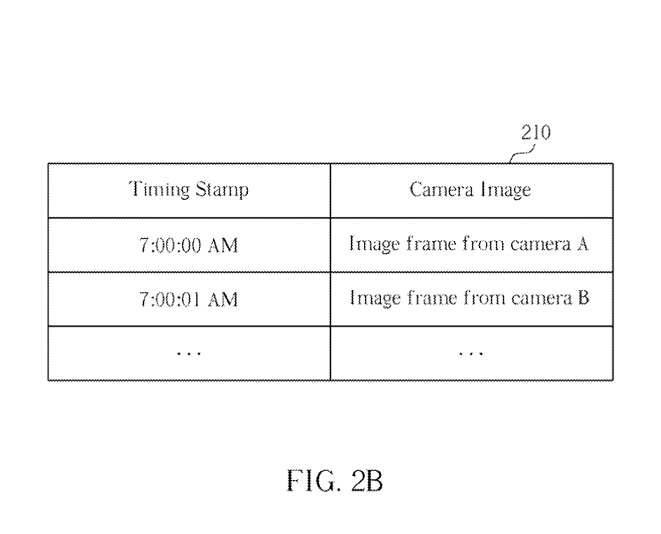

Please refer to FIG. 2A, which is a schematic diagram of an exemplary image processing system 200. The image processing system 200 can be an implementation of the image processing system 160 and may be referred to as a microprocessor board. The image processing system 200 includes a RFID reader unit 220, a microprocessor module 240 and a memory unit 260. The RFID reader unit 220 is used for retrieving the tag data through the antenna array 120. The operation of the RFID reader unit 220 is well known by those skilled in the art, and thus omitted herein. The microprocessor module 240 is coupled to the RFID reader unit 220 and used for receiving the image data from the camera set 140 and correlating the tag data with the image data to generate the combination data. Preferably, the microprocessor module 240 can be carried out by a chip, Davinci DM6446. The Davinci DM644 includes an Acorn RISC Machine (ARM) and a video processor (not shown in FIG. 2A). The ARM is coupled to the RFID reader unit 220 and is responsible for processing the tag data. The video processor is coupled to the camera set 140 and processes the tag data and the image data received from the camera set 140. The video processor of Davinci DM6446 uses H.264 protocol, which includes digital compression for low bit rate transmission such as low speed internet connection and the imaging motion compensation feature which corrects the blurred image into blemished-free quality image. When the object images are captured by the camera set 140 and transmitted to the video processor, the video processor performs a post-imaging processing. The post-imaging processing is the process of changing the perceived quality of a video on playback (done after the decoding process). This helps reduce or hide image artifacts and flaws in the original film material. In addition, Davinci DM644 has 2 video inputs. The video inputs have NTSC/PAL, S-video selection commonly used in video protocols. NTSC and S-video will be preferences since NTSC format is US commission standardization protocol for TV broadcast and S-Video is used in PC monitor protocol. The memory unit 260 is coupled to the microprocessor module 240 and used for storing the combination data. The combination data including the image data and the timing stamp information is updated to the memory unit 260. The memory unit 260 may be implemented by a security digital (SD) card. For example, a 32 GB SD card may last 15 hours of recording duration. Since the combination data includes information of the tag data and the image data this may help identify the person who holds the object with the tag attached. The user may easily find out the exact location where the person is located at.

In addition, the image processing system 200 may be connected to some output devices such as a host computer, PC monitor or High-Definition (HD) output. The image processing system 200 may further include an Ethernet port or/and digital to analog converter (DAC). The host computer may keep being updated with new combination data in real time via the Ethernet port so the user can track objects of interest on the host computer. Alternatively, the user may monitor the objects of interest on the PC monitor or HD output. In this situation, the DAC is used for performing digital signal process to resize image frame of the combination data.

Please refer to FIG. 2B, which illustrates an exemplary data structure 210 of the combination data. As seen in FIG. 2B, when a camera A is recording at time 7:00:00 AM, the image frame from the camera is put into the hard-drive after video posting processing. In the meanwhile, when the hard-drive was writing the image frame at time 7:00:01 from the camera A, the video processor is using the codec functionality to do the image post processing with image frame from a camera B and then pour all the data into the hard-drive. The cameras A and B can be implemented by the camera module 141.

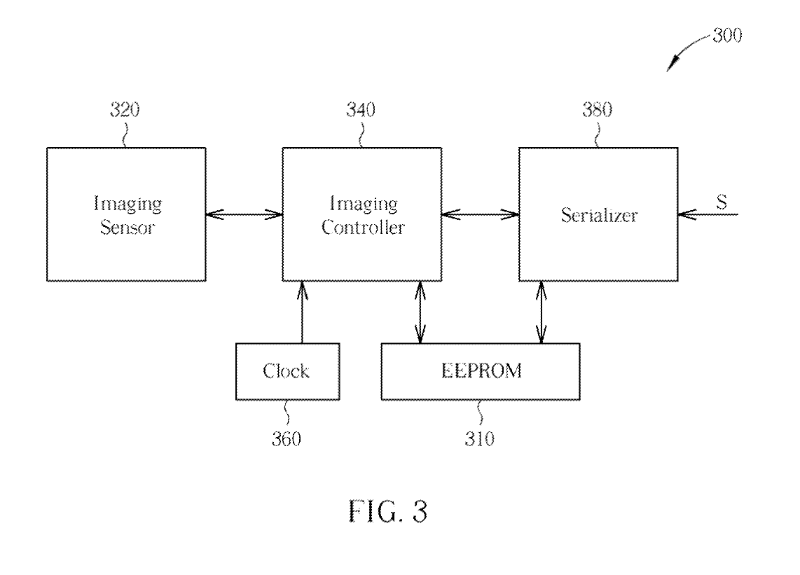

Please refer to FIG. 3, which is a schematic diagram of an exemplary camera module 300. The camera module 300 can be anyone of the camera modules 141 shown in FIG. 1. The camera module 300 includes an imaging sensor 320, an imaging controller 340, a clock 360, a serializer 380, and an EEPROM unit 310. The imaging sensor 320 is used for capturing the images of the objects. The imaging controller 340 is coupled to the imaging sensor 320 and used for configuring and synchronizing the image sensor 320 according to an image configuration. The clock 360 is coupled to the imaging controller 340 and used for providing a clock sequence for the imaging controller 340. The serializer 380 is coupled to the imaging controller 340 and used for converting the image data in a parallel data type into a serial data type and transferring a control signal S. The control signal S comes from the microprocessor module 240. The serializer 380 integrates the parallel data into the serial data, thereby reducing the image data originally from 18 differential signals to one differential signal and thus the maximum cabling length can reach up to 10 meters long. The EEPROM unit 310 is coupled to the imaging controller 340 and the serializer 380 and used for sending the image configuration to the imaging controller 340 according to the control signal S. The imaging sensor 320 may keep on sending the image data stream to the image processing system 200. The imaging controller 340 synchronizes and controls the mechanism of image sensor 320 such as the image resolution, focal point setting and image quality control. With the EEPROM unit 310 mounted, the microprocessor module 240 sends a command to EEPROM unit 310 via I2C control lines. The image configurations pop up from the EEPROM unit 310 and are sent to the imaging controller 340. In this case, the microprocessor module 240 does not need to send all image configurations to the serializer 380, avoiding the timing overhead.

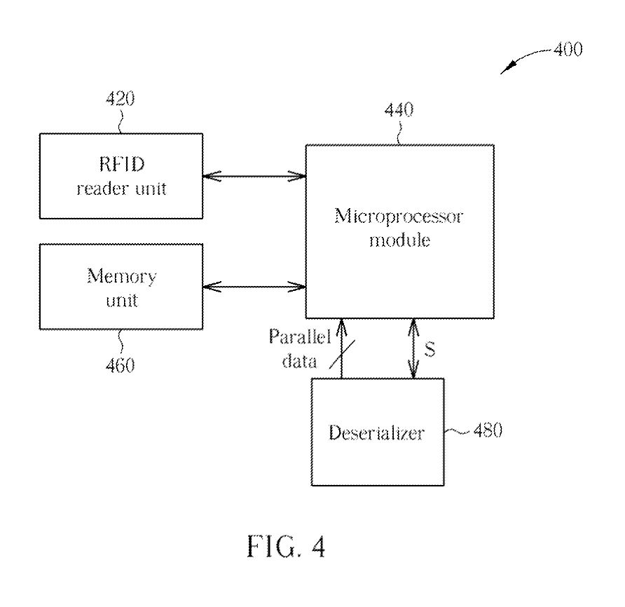

In general, the serializer 380 is always paired with a deserializer. The deserializer converts the serial data back to the parallel data. Please refer to FIG. 4, which is a schematic diagram of another exemplary image processing system 400. The image processing system 400 includes a RFID reader unit 420, a microprocessor module 440, a memory unit 460 and a deserializer 480. The RFID reader unit 420, the microprocessor module 440 and the memory unit 460 has identical or similar functionality with the RFID reader unit 220, the microprocessor module 240 and the memory unit 260. The deserializer 480 is coupled to the microprocessor module 440 and is used for converting the image data in the serial data type into the parallel data type and transferring the control signal S. Please note that the image processing system 400 may include multiple deserializers, not only limited to one.

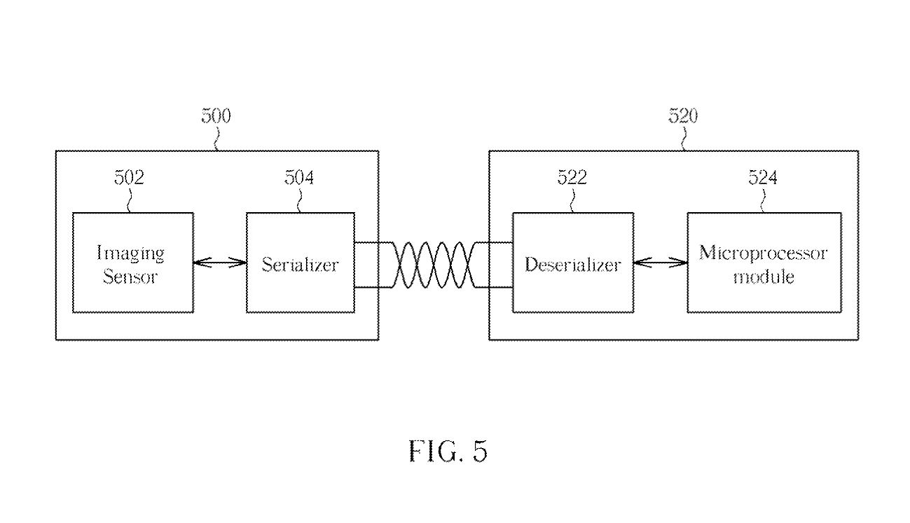

In some examples, the camera set 140 only has one camera module. Please refer to FIG. 5, which illustrates connection between a camera module 500 and an image processing system 520. Since the serializer 504 and the deserializer 522 are used, the image data can be reduced from 18 differential signals to one differential signal. Some components in the camera module 500 and the image processing system are not shown in FIG. 5.

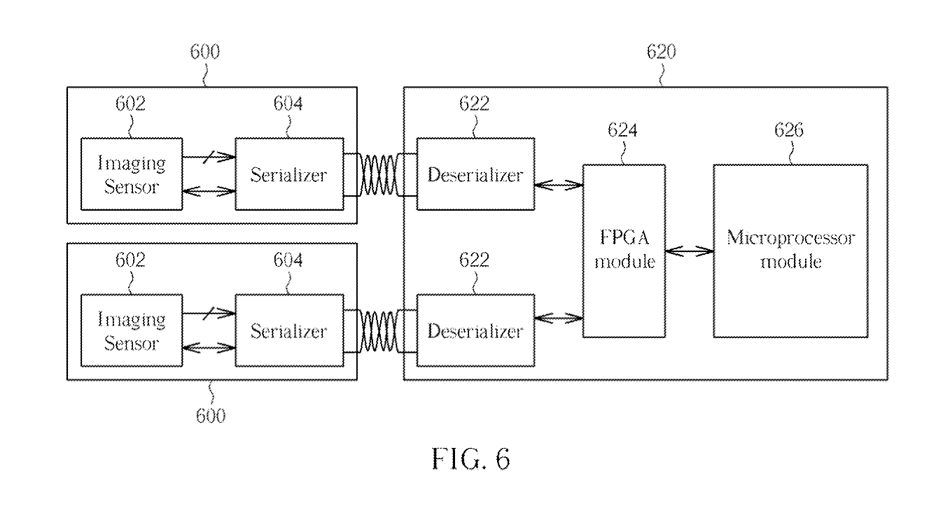

In some examples, the camera set 140 has multiple camera modules. Take a camera set of two camera modules as an example, FIG. 6 illustrates connection between two camera modules 600 and an image processing system 620. The image processing system 620 includes two deserializers 622. Since there are two cameras ports attached on the image processing system 620, one multiplexer or digital switch may be needed here. A Field-programmable Gate Array (FPGA) module 624 is adapted in the image processing system 200 and functions as a multiplexer or a digital switch. The FPGA module 624 is coupled to the two deserializers 622 and the microprocessor module 626 and used for multiplexing the image data receive from the two deserializers 622. Another benefit of use of the FPGA module 624 is that the FPGA module 624 has the timing recovery mechanism to correct the signal integrity. The FPGA module 624 is cheap compared to a channel link chip. Moreover, use of the FPGA module 624 also extends other logic control in the future, which also adds more flexibility and extensibility. The operations of the FPGA 624 is well known by those skilled in the art, and thus omitted herein.

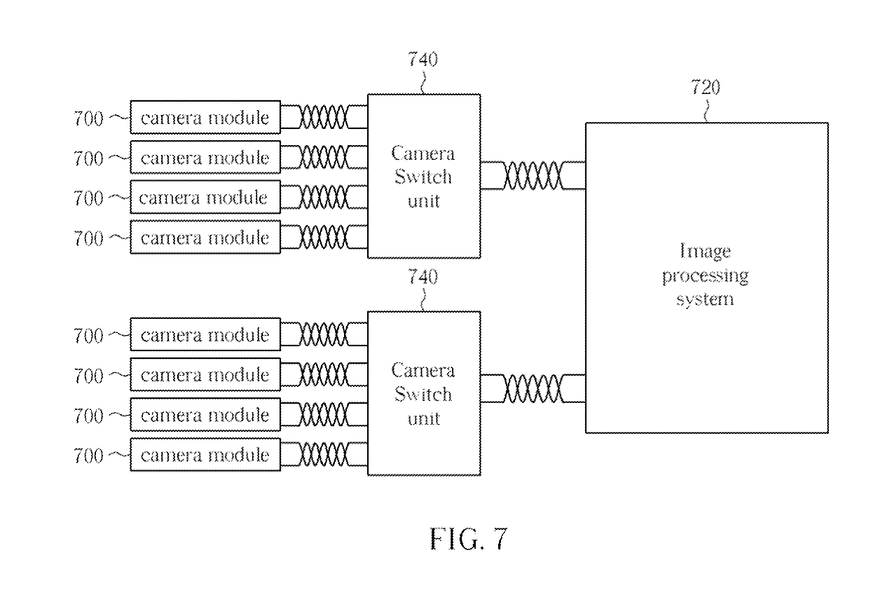

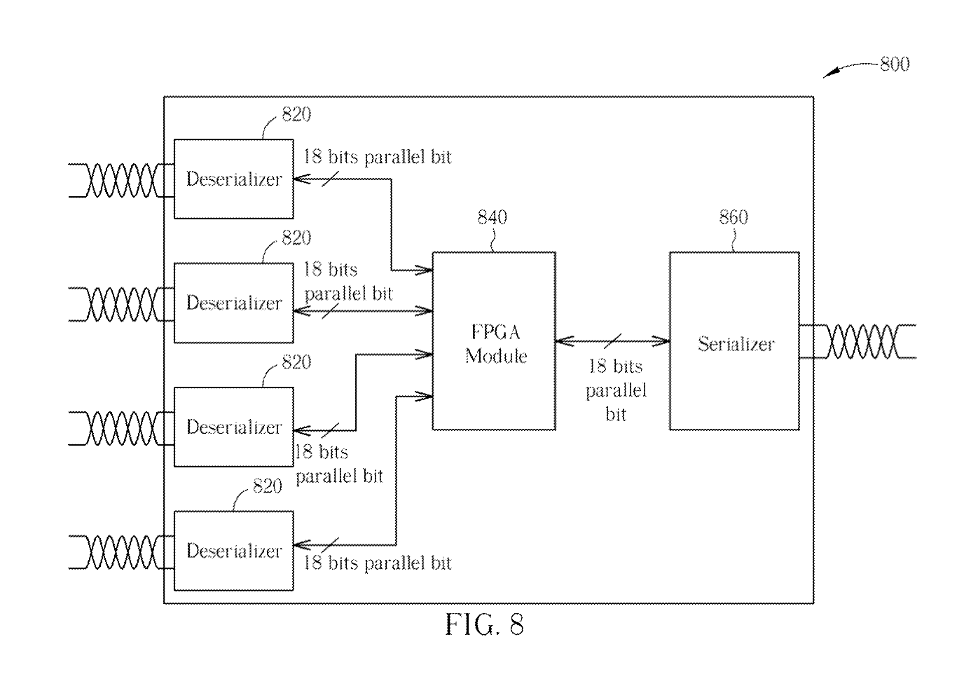

In another example of the present invention, the camera set 140 extends the number of the camera modules up to eight. Please refer to FIG. 7, which illustrates connection between eight camera modules 700 and an image processing system 720. As seen in FIG. 7, two camera switch units 740 are used for switching the multiple camera modules 700 to transfer the image data. The image processing system 720 is similar to the image process system 620. Please refer to FIG. 8, which is a schematic diagram of a camera switch unit 800. The camera switch unit 800 can implement any of camera switch units 740 shown in FIG. 7. The camera switch unit includes four deserializers 820, a FPGA module 840 and a serializer 860. Likewise, the FPGA module 840 is used for data piplining and the signal timing recovery purpose due to the elongated cabling length problem. In this example, only one camera module can be used at one time. Multiple image frames may be merged into one frame according to the FPGA application.

Please note that those skilled in the art can extend the number of the camera modules in the camera set 140 according to requirements. Accordingly, changes may be made in the elements described herein without departing from the sprit and scope of the present invention.

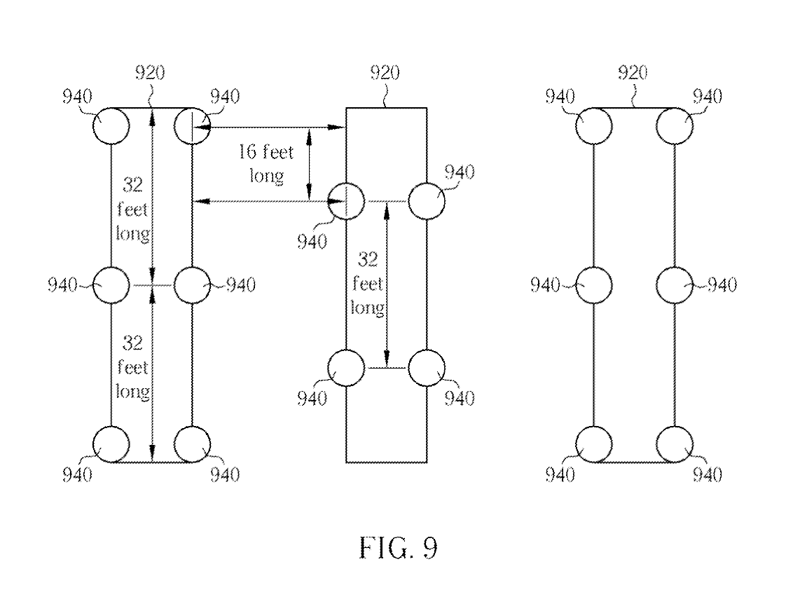

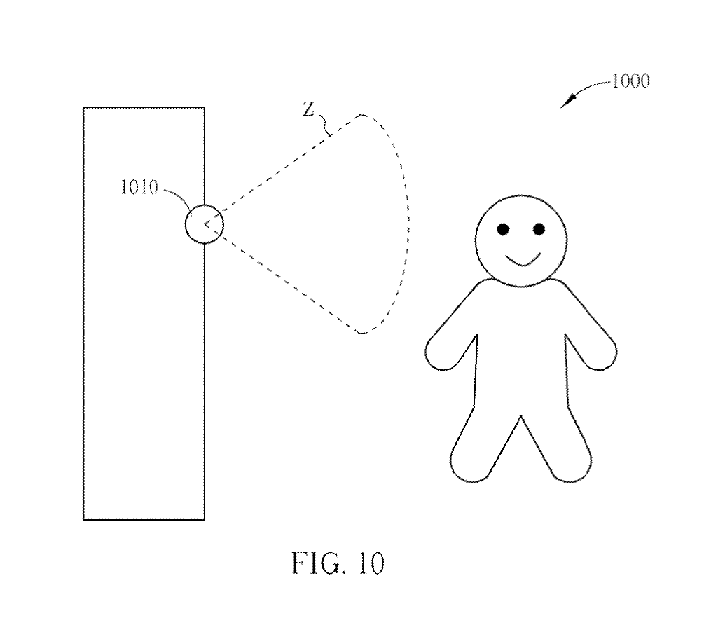

Please refer to FIG. 9, which illustrates an exemplary camera deployment 900 of the camera set 140. In FIG. 9 there are selves 920 and multiple camera modules 940. The camera modules 940 of the deployment 900 positioned along each shelf 920 should keep at least 32 feet apart. The camera modules 940 on the adjacent shelf should be placed in-between position where the coverage zones of each camera module 940 can be overlapped. The distance between each shelf 920 should be at least 16 feet long. If there is only one camera module in the camera set 140, an exemplary camera deployment 1000 of the camera set 140 can be illustrated as FIG. 10. A vertical field of view Z of the camera module 1010 should cover the facial part of human body. Those skilled in the art may change the number of the cameras according to the field of view of the cameras, location, area size and etc.

Furthermore, the image processing system 160 processes may further combine the image data with different kinds of data such as temperature data, acoustic data and the like. One or more acoustic sensor (sonar) or Ultrasonic distance ranger could be mounted on the camera set 140. These acoustic sensors or Ultrasonic distance rangers send an acoustic signal out and wait for the echo to return and measure the distance based on the time required for the echo to return. The RFID reader unit 200 may further receive the acoustic signal and then the acoustic signal is sent to the microprocessor module 240 via I2C synchronous serial protocol interfacing. The acoustic sensors or Ultrasonic distance rangers may have cone shaped field sensitivity that about 55 degrees wide and 6 meter long measure distance from the sensor itself to the edge of the range. Please note that no two of acoustic sensors are operating at the same time since the acoustic signals may interfere each if both of the acoustic sensors turn on simultaneously. Thus, when an intruder who does not hold any object with a RFID tag attached on break in the store, the monitoring system 10 can be aware of the intrusion and take a photo of the intruder with sufficient information (e.g. timing stamp information). As a result, the user or owner can easily find out the exact location where the intruder is located at and when exactly the intruder breaks in.

To sum up, an image processing system correlates the tag data with the image data to generate the combination data. The combination data can bring more information such as timing stamp information or an identity of each object. This may help the user to identify a person who holds the objects with RFID tag and easily to find out where the person is located. Once the object has been stolen or removed, the user can differentiate who steals the object or which object is stolen immediately by watching the output device (e.g. host computer or HD output) without making mistake.

Those skilled in the art will readily observe that numerous modifications and alterations of the device and method may be made while retaining the teachings of the invention. Accordingly, the above disclosure should be construed as limited only by the metes and bounds of the appended claims.

1. An image processing system comprising:
a radio frequency identification (RFID) reader unit for retrieving tag data, wherein the tag data comprises timing stamp information;
a microprocessor module coupled to the RFID reader unit, for receiving image data and correlating the tag data with the image data to generate combination data, wherein the combination data comprises information of the tag data and the image data; and
a memory unit coupled to the microprocessor module, for storing the combination data.

2. The image processing system of claim 1 further comprising an Ethernet port for sending the combination data to a host computer.

3. The image processing system of claim 1 further comprising at least one deserializer coupled to the microprocessor module for converting the image data in a serial data type into a parallel data type and transferring a control signal.

4. The image processing system of claim 1 further comprising a Field-programmable Gate Array (FPGA) module coupled to the at least one deserializer and the microprocessor module for multiplexing the image data receive from the at least one deserializer.

5. The image processing system of claim 11, wherein the RFID reader unit further receives an acoustic signal detected by an acoustic sensor.

6. The image processing system of claim 15, wherein the microprocessor module further processes the acoustic signal and the image data.

7. A monitoring system comprising:
an antenna array for receiving tag data corresponding to a plurality of objects;
a camera set for capturing images of the plurality of objects and generating image data according to the images, the camera set comprising at least one camera module; and
an image processing system coupled to the camera set for processing the image data and the tag data, the image processing system comprising:
a radio frequency identification (RFID) reader unit coupled to the antenna array for retrieving the tag data, wherein the tag data comprises timing stamp information;
a microprocessor module coupled to the RFID reader unit, for receiving image data and correlating the tag data with the image data to generate combination data, wherein the combination data comprises information of the tag data and the image data; and
a memory unit coupled to the microprocessor module, for storing the combination data.

8. The monitoring system of claim 7 further comprising a plurality of RFID tags attached to each of the plurality of objects.

9. The monitoring system of claim 7, wherein the image processing system further sends the combination data to a host computer via an Ethernet port.

10. The monitoring system of claim 7, wherein the image processing system further comprises:
at least one deserializer coupled to the microprocessor module for converting the image data in a serial data type into a parallel data type and transferring a control signal.

11. The monitoring system of claim 10 further comprising a Field-programmable Gate Array (FPGA) module coupled to the at least one deserializer and the microprocessor module for multiplexing the image data receive from the at least one deserializer.

12. The monitoring system of claim 7, wherein each of the at least one camera module comprises:
an imaging sensor for capturing the images;
an imaging controller coupled to the imaging sensor, for configuring and synchronizing the image sensor according to an image configuration;
a clock coupled to the imaging controller, for providing a clock sequence for the imaging controller; and
a serializer coupled to the imaging controller for converting the image data in a parallel data type into a serial data type and transferring a control signal; and
an EEPROM unit coupled to the imaging controller and the serializer, for sending the image configuration to the imaging controller according to the control signal.

13. The monitoring system of claim 7 further comprising a camera switch unit coupled to the camera set and the image processing system for switching the at lease one camera module to transfer the image data.

14. The monitoring system of claim 7 further comprising a digital signal process unit coupled to the image processing system for adjusting resolution of the combination data.

15. The monitoring system of claim 7, wherein the RFID reader unit further receives an acoustic signal detected by an acoustic sensor.

16. The monitoring system of claim 15, wherein the microprocessor module further processes the acoustic signal and the image data.
